(19) United States
(12) Patent Application Publication
(10) Pub. No.: US 2005/0037325 A1
(43) Pub. Date: Feb. 17, 2005

(54) Method and apparatus for publication of a dynamic report card

(76) Inventor: Donald Dean Brown, Bend, OR (US)

Correspondence Address: Donald D. Brown, 559 S.E. Centennial, Bend, OR, 97702, US

(21) Appl. No.: 10/640,440

(22) Filed: Aug. 14, 2003

(51) Int. Cl. G09B 7/00

(52) U.S. Cl. 434/353; 434/350; 434/362; 434/322; 434/323

(57) ABSTRACT

Methods and apparatuses are disclosed for collection and publication of a user/student's performance with respect to an academic course. a central collection site passively receives answers to questions from students over a transport medium as transmitted by student devices. a result is derived from the received answer and then stored in a memory device in a results file. The stored results correspond 1 to 1 with the original questions also stored in the memory device in a question file. The results and corresponding questions are made available to interested parties in a graphic or numeric dynamic report card. Thus the continous assessment of student achievement according to an interested party's own criteria rather than threshold type grades is permitted.

### BACKGROUND OF THE INVENTION

While much work has been done on the problem of testing and learning by computer or online, the problem of publishing and reporting student results has not received the same attention. Currently the only method available for evaluation of student performance in a course is grades, a grade being a measure at a time fixed of student progress against a certain threshold of achievement and understanding.

An admissions officer looks at grade point average for all classes over several years; a parent looks at a report card containing a grade in a subject over a semester; even a teacher looks at test grades which provide periodic snapshots of performance over a term.

Educational software that tests a user's knowledge, coupled with the immediate scoring of answers, is well-known in the art. For home use, a wide range of software is directed to various age groups. These educational programs generally present players with a series of increasingly difficult tests, wherein players must correctly solve the present round before they are allowed to continue to the next round of play. These programs are individual in nature and do not contemplate publication of results or grades.

Another category of educational software runs on networked server-and-client systems for large-scale, testing of students. The software subsequently retains test grades in a local database allowing a teacher to evaluate student performance, to ensure that all students have achieved certain minimum threshold levels and to assign and publish appropriate grades.

Yet another category of software is used for a computerized evaluation of standardized tests taken by school children using paper forms.

Groups of students simultaneously record their answers to paper-based, multiple-choice questions by blackening ovals on forms which are optically scanned for grading by software running on computers. A standard paper report is then generated and distributed to each student. These reports, such as the SATs, measure a student's performance and publish a numeric grade.

The invention described here provides a means to dynamically publish student progress so that all of the parties interested in a student's performance may continously monitor which questions in which subjects have been mastered by a student, thus permitting such parties to determine by subjective or objective criteria whether such performance is satisfactory without assigning grades. One consequence of this method is that student performance need not conform to fixed periods of time, enabling a student to progress through a course independent of a class. Another consequence is that an interested party could farm student results for promising applicants with specific skills.

### BRIEF SUMMARY OF THE INVENTION

In one embodiment of the invention, testing software is incorporated into an internet site reporting a user's question results. Whenever a student completes a question, the student transmits his or her answer via an html submit button to the internet site where a result of correct, incorrect or possibly partial credit is derived and stored in a 1 to 1 correspondence to the originating question. The information thus received and stored provides the subsequent input into a dynamic report card.

When a new student calls for the first time, a signup page creates a user record in a central database or results file. The created record has fields containing the user's name, password, academic course to be undertaken, and a field to contain the results of student answers to questions. For subsequent call-ins, the username and password are automatically connected with the created record.

After the the central computer of the internet site evaluates an answer and saves the result of correct/incorrect in the central database, the individual question results remain available to interested parties for comparative evaluation against appropriate criteria. Access by interested parties is restricted by passwords in a separate signup page. The criteria used will typically include demographic or geographic factors, but could be any objective or subjective measure.

In other embodiments the testing software may be located on a network not internet connected or on an individual user's computer. The common element of any embodiment is the storage of question results in 1 to 1 correspndence with the originating question, and publication of the results in the dynamic report card format for continous access by interested parties. The results are reportable in graphic and/or numeric form, and connect to the question relating to any result.

For an embodiment which is located on individual user/student computers, the question results must be uploaded to a central location or the user computer must be connected to a network for access by interested parties.

The dynamic report card provides information regarding the total number of questions in a course, the highest question successfully answered, and which questions have incorrest results. Using this invention, user/student results are made available to permitted interested parties continuously. The user/student may access and attempt questions at times and over a period of time suited to the student.

### BRIEF DESCRIPTION OF THE DRAWINGS

The following are exemplary illustrations of components of the apparatus and method.

FIG. 1: the basic components of an embodiment of a system for publishing a dynamic report card.

FIG. 2A: program logic.

FIG. 2B: program logic.

FIG. 3: graphic display of student results in report card.

FIG. 4: numeric display of student results in report card.

FIG. 5: student record in the results file.

FIG. 6: question display from report card.

### DETAILED DESCRIPTION OF THE INVENTION

Methods and apparatuses are disclosed for storage and publication of a student's performance with respect to an academic course.

In this disclosure, certain hardware and software elements used in conjunction with the dynamic report card device are well understood to those skilled in the art and are not shown in order not to obscure the present invention. Thus excluded are the operating system and server software necessary to support the common gateway interface (cgi) programs which implement the dynamic report card functions, and also the transport medium which connects the central computer device to remote students and remote interested parties.

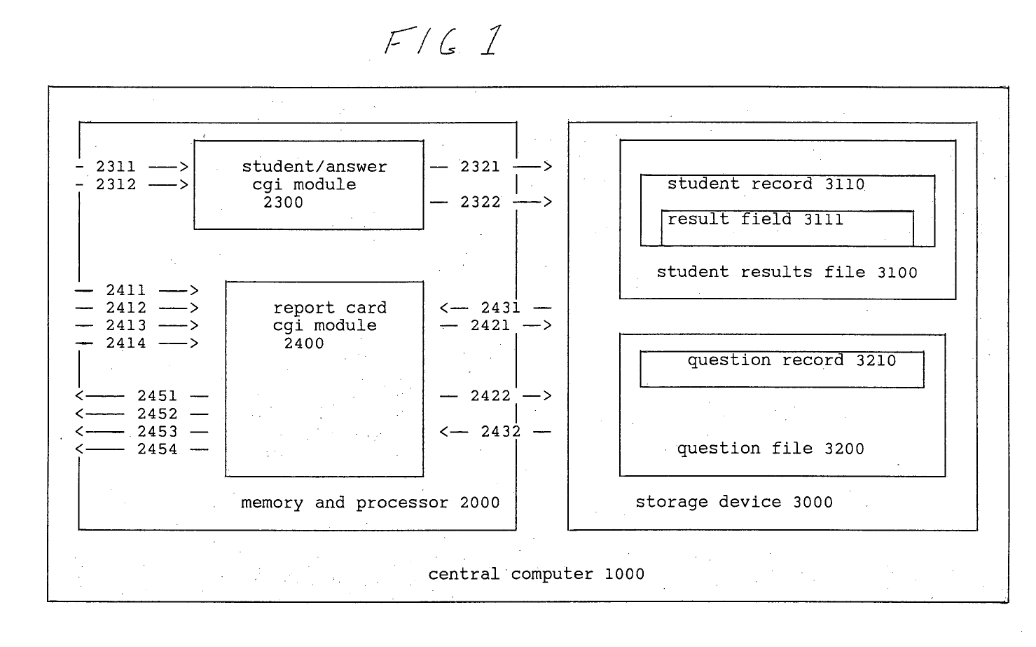

FIG. 1 shows a schematic of the components of the physical apparatus configured to implement the invention. The central computer 1000 contains memory and processor 2000 and storage device 3000. The memory and processor 2000 are configured by loading the instructions of the cgi modules 2300, 2400 into memory.

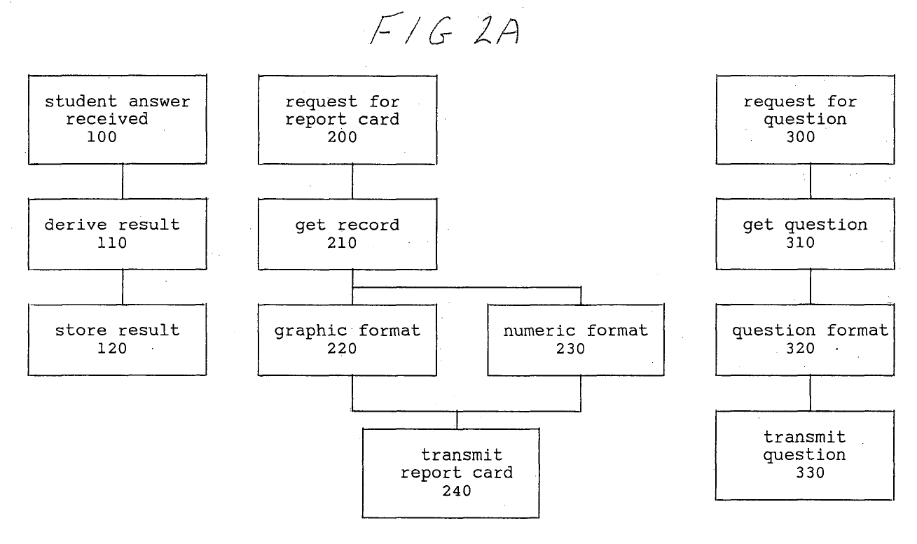

At the left side of FIG. 1, the cgi modules 2300, 2400 receive and transmit signals via the transport medium to remote devices. On the right side, signals are transmitted to and received from the storage device 3000. In the preferred embodiment the transport medium signals are in the form of received html requests and transmitted html pages; the storage signals are reads and writes via a file system. A detailed description of these signals is deferred to the discussion of FIG. 2A and FIG. 2B below.

Continuing with FIG. 1, the computer-based dynamic report card system is utilized by a student at a testing computer (not shown) who typically exchanges information with the central computer 1000 using a transport medium connected to a receiver at the central computer. The preferred embodiment for these apparatuses are a student personal computer (not shown) transmitting answers over the internet to an ethernet modem at the central computer 1000. Another embodiment would be answers transmitted over a public telephone network provided by a local or regional telephone operating company to a serial line modem and server computer implementing a bullletin board service or bbs. Any other direct or indirect communication link could also be used. The dynamic report card system thus implements the reception of question answers 2311 by the central computer 1000, and the generation and publication of a student's dynamic report card 2451, 2452 to an interested party.

The central computer data storage device 3000 is used to store the question file 3200 and the result file 3100. The result file 3100 contains results produced by the receiving cgi software component 2300, which results comprise a cumulative record of all answers to all questions attempted by the student. The student record 3110 in result file 3100 also maintains data on the student including names, personal ID numbers, course name. Most importantly it maintains the results field 3111.

Data storage device 3000 reads either fixed storage media within the central computer 1000, or removable storage media external to the central computer 1000. Such media could include high capacity magnetic (e.g., hard disk), optical (e.g., CD-ROM), or magneto-optical media, as well as low capacity media such as flash memory.

As noted above, the central computer 1000 includes a CPU and memory 2000 capable of executing the dynamic report card software implemented in the cgi modules 2300, 2400. The central computer 1000 receives a question answer from a user/student, and compares the answer against the correct answer (retreived from the question file 3200 or transmitted round trip in the hidden html to the user with the question then back to the server with the answers). The result of the comparison, correct/part_correct/incorrect, is then stored in the student record 3110 in the question result file 3100. A crucial part of this storage procedure is the one to one correspondence maintained within the result field 3111 of the student record 3110. The results are not summarized into grades and the one to one correspondence between the originating questions and the stored results 3111 is always maintained.

After the the central computer of the internet site evaluates the answer and saves the result of correct/incorrect in the central database, the individual results remain available to interested parties for evaluation. Upon receiving a request for a report card pertaining to th student, the central computer 1000 then generates a graphic or numeric report card 2451, 2452 and presents the report card (in html format) over the transport medium to the remote interested party. Because the central computer 1000 might be simultaneously performing these operations for a multitude of students and interested parties, it must be capable of high-volume transaction processing and of processing a significant number of data inquiries. Thus a relatively powerful processor that has a wide data bus would be a suitable CPU.

An interested party can be the student himself, an instructor, a college admissions office, or any other party having an interest in the performance of the user/student. In the exemplary embodiment shown in FIG. 1, the report card elements 2451, 2452, 2453 are shown as being generated by the report card cgi component 2400 for transmission over the transport medium (not shown) to an interested party (not shown) for display by browser software at a remote location. In the further discussion below the term instructor is used interchangably with the term interested party.

Referring now to FIGS. 2A and 2B, there is shown an exemplary embodiment of the logical processes for receiving an answer and publishing a dynamic report card. As a matter of convenience, the elements of the system will be referenced as four digit numbers from FIG. 1, although such numbering is not shown in the process description of FIGS. 2A and 2B (3 digit numbers).

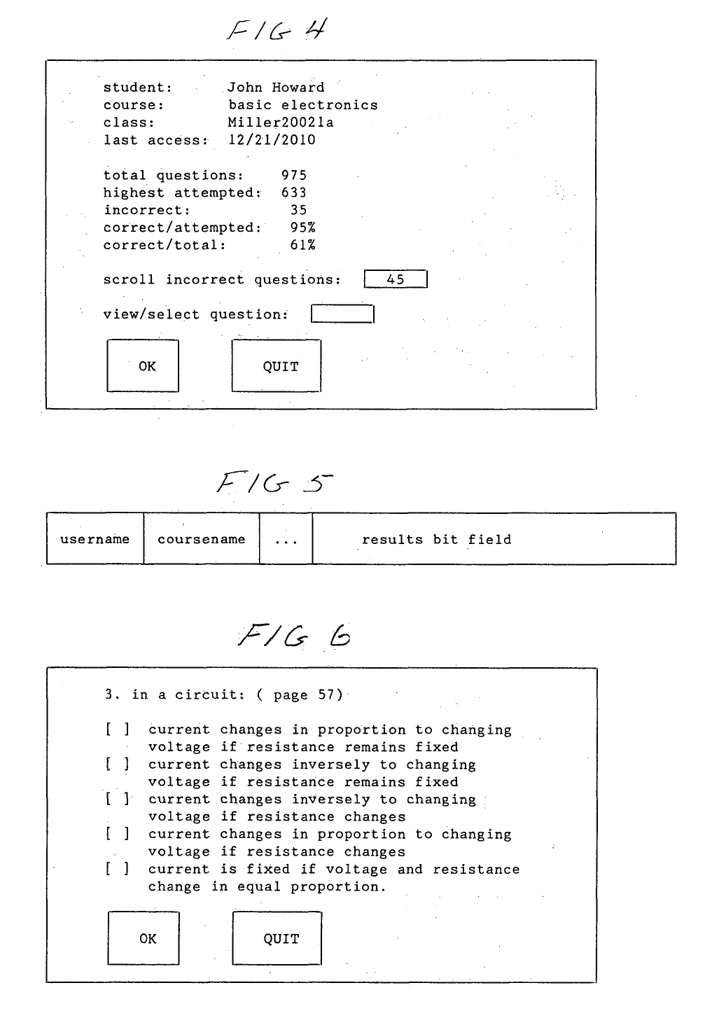

Turning first to the process logic for receiving an answer, at step 100, an html encoded answer to a question 2311 is received. Questions can include true/false, multiple choice, fill-in-the-blank, or any other machine-scorable format. At step 110, the receiving/student software 2300 scores the question by comparing the answers provided by the student/user to the correct answers stored within the question file. At step 120, the question results 2321 are incorporated into the results field 3111 of the user record 3110 in the result file 3100. A 1 to 1 correspondence must be maintained between the originating question and the stored result. FIG. 5 illustrates an exemplary embodiment of a student record in the results file.

The cumulative results remain available to interested parties in the user/student database 3100 for comparative evaluation against appropriate criteria.

FIG. 2B illustrates initial sign up. If the student/user has not yet registered with the central computer 1000, a signup page 2312 is received by cgi module 2300 at step 400 from the user/student for registration. The registration information might include the student's name, course name, password. This information is translated into the results file format 2322 in step 410 and stored in device 3000 as student record 3110. The record is appended to the results file 3100, and is indexed by name and personal ID number. The user/student is then fully registered with the central computer 1000 which is ready to receive answers 2311. Note that there is no log-in process after the student record 3110 is created and that the process logic 2300 is entirely passive. Answers are received from student devices with no reciprocal transmission required from this storage process.

Continuing with FIG. 2A, now consider the process logic for generating a report card in a graphic 2451 or numeric 2452 format and displaying questions 2453 pertaining to the results shown in the dynamic report card.

First, in step 200, an interested party such as an instructor submits a request for a student report card. Request 2411 specifies a graphic display. Request 2412 specifies a numeric display. The request is received at the report card cgi module 2400 running on the central computer 1000. The report card cgi software 2400 retrieves the student record 3110 at step 210 via file signal 2421 sent to the storage device 3000 and receives student record 2431 from the storage device. Cgi module 2400 then composes the requested graphic or numeric form report card 2451, 2452 at steps 220 (graphic) and 230 (numeric). The numeric display 2452 shows one or more of: the highest question for which there is a correct result, the total number of questions in the course, the number of incorrect results, the question numbers for the incorrect results, the correct results as a percentage of attempted questions, the correct results as a percentage of the total number of questions, the time of last access. The graphic format 2451 portrays an arrangement of symbols representing the results for individual questions, and may also display some or all of the elements of the numeric display. At step 240 the selected report card is transmitted to the requesting party.

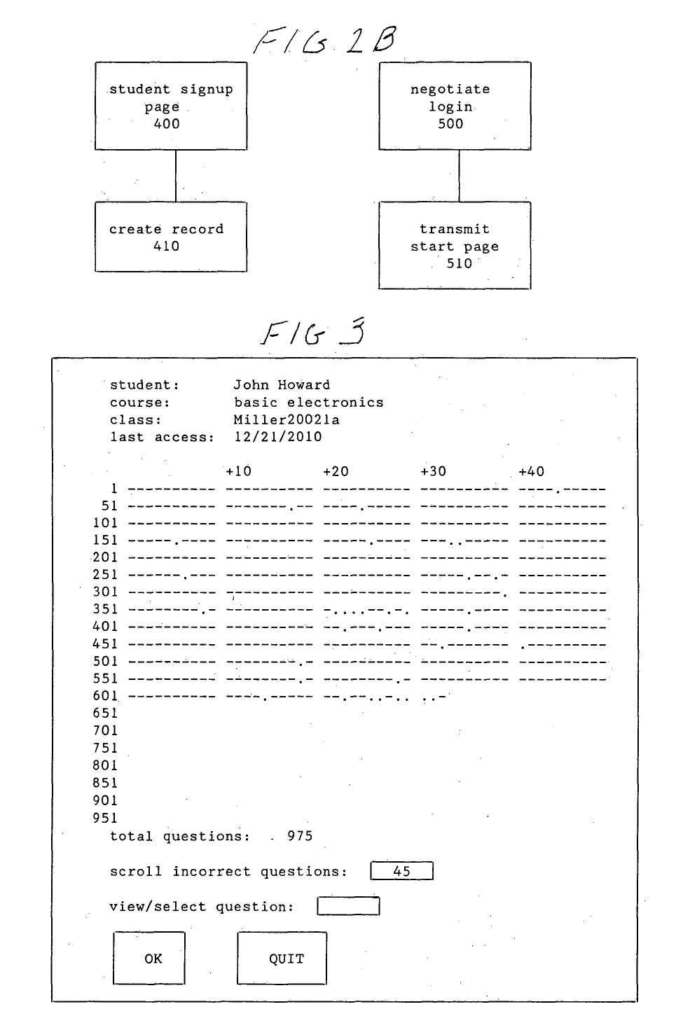

FIGS. 4 and 3 show respectively exemplary numeric and graphic displays resulting from the transmitted report card formats.

Continuing again with FIG. 2A, either format report card provides a data entry field from which a question number may be entered, the question file 3200 accessed, and the text of a question retrieved and viewed by an interested party.

In step 300, a question display request 2413 is received at the central computer 1000. The report card cgi software 2400 retrieves the applicable question 3210 at step 310 via file signal 2422 sent to the storage device 3000 and receives the question text 2432 from the storage device. Cgi module 2400 then composes the requested question html display 2453 at step 320. At step 330 the question display is transmitted to the requesting party. FIG. 6 shows an exemplary question display resulting from the transmitted question html.

At the remote end (not shown) an interested party may receive a print out of any display using the capture and print facility of the remote browser.

Continuing again with FIG. 2B,

The process logic for generation of the report card actively interacts with an interested party. Consequently the report card cgi module 2400 has a login process beginning with step 500 of FIG. 2B. There, a log-in request 2414 containing a username and password is received and negotiated. The logic proceeds to step 510 where a start form 2454 is transmitted. The start form enables an interested party to request a student report—step 200 of FIG. 2A.

Alternative Embodiments of the Invention.

The above embodiments have been described with respect to a system utilizing a internet network connection between the students or instructors and the central computer 1000. However any other method using a direct electronic connection via a dial-up modem, a cable modem, a set-top box, or any other form of electronic communication could be used. For example, conventional modems operating over a serial telephone connection between the central computer 1000 configured as a bbs (bulletin board service) and remote terminals running serial communications programs could also work. The central computer's network interface must be able to support multiple, simultaneous data connections in any embodiment.

Indirect Communication Between Remote Devices and the Central Computer 1000.

In another embodiment, the remote student terminal would intermittently contact the central computer 1000, using a dial up telephone connection to transmit a number of answers to questions to the central computer 1000. In this embodiment of the invention, the test questions would be stored at the remote device rather than stored at and downloaded directly from, the central computer 1000. In such cases, the result 2321 could alternatively be stored on the remote device for intermittent transmission to the central computer 1000 where the results would be published. The central computer 1000 in this case only maintains the user/student result file 3100 for access by interested partiers and generation of dynamic report cards.

Distributed Computing.

In another embodiment of the invention, the cgi software 2300, 2400 could be programmed in a distributed computing language that allows both the functional (result derivation) and non-functional (questions) aspects of the testing software to be integrated into “executable content” accessible from a remote server over the World Wide Web. Even more sophisticated distributed computing protocols allow the processing of information by different computers operating in a networked environment, allowing the central computer 1000 (or any other networked computer) to perform the functions of the cgi software 2300. 2400.

In a similar manner, while the above embodiments describe a single computer acting as the central computer 1000, those skilled in the art will realize that the functionality of the central computer 1000 can be realized among a plurality of computers. Thus, in an alternative embodiment of the inventions the central computer 1000 may be configured as a distributed architecture wherein the results file and question file are housed in physically separate units. In such a configuration, each unit is in communication with its constituent parts, but the processor and/or data storage functions are performed by stand-alone units.

For purposes of illustration only, and not to limit generality, the present invention has been explained with reference to various examples of computing devices. However, one skilled in the art will appreciate that the invention is not limited to the particular illustrated embodiments or applications, but includes many others that operate in accordance with the principles disclosed herein.

1. In an education environment wherein results of student testing are received via a transport medium in a centralized location, a method for collecting and publishing a dynamic report card comprising at the centralized location:
one or more question files containing the questions posed to students;
one or more result files containing results of student answers to questions;
a process for receiving answers to questions from student devices;
a process for storing the result derived from a received answer in a result file in 1 to 1 correspondence with the originating question;
a process for presenting said results over the transport medium in a graphic or numeric form report card; and
a process for providing access to the originating questions corresponding to said results presented in the graphic or numeric form report card.

2. The method according to claim 1 wherein the step of storing a result comprises: finding the student/course record within the result file; finding the result field within the student record; locating the bit positions within the result field which correspond 1 to 1 with the originating question; and, altering the bit positions according to the result.

3. The method according to claim 1 wherein the step of storing a result comprises: finding the student/course record within the result file; finding the result field within the student record; and, writing a result/question_id pair into the result field thus replacing any existing pair having the same question_id.

4. The method according to claim 1 wherein the step of presenting a student's results comprises:
retrieving the student/course record from the result file; finding the result field within the student/course record; providing
a graphic or numeric summary display of the results.

5. The step of presenting a student's results according to claim 4 wherein the numeric summary display comprises one or more of: the highest question for which there is a correct result, the total number of questions in the course, the number of incorrect results, the question numbers for the incorrect results, the correct results as percentage of the total number of questions, the correct results as a percent of attempted questions, the time of last accees, a test entry field for requesting the display of a question by number.

6. The step of presenting a student's results according to claim 4 wherein the graphic summary display illustrates one or more of: the highest question for which there is a correct result, the total number of questions in the course, the incorrect question results distinguished from correct question results in a graphic or symbolic display, the question numbers for the incorrect results, the correct results as percentage of the total number of questions, the correct results as a percent of attempted questions, the time of last accees, a test entry field for requesting the display of a question by number.

7. The method according to claim 1 wherein the step of providing access to an originating question comprises:
receiving a user-entered question number query, retrieving the text of the specified question from the question file, and transmitting a displaying the text of the question via the transport medium.

8. An apparatus for publishing a dynamic report card comprising:
a central computer device configured as a receiver for receiving student answers over a transport medium;
a storage device, coupled to the central computer device and configured with one or more result files for collection of results of student answers to questions;
a storage device, coupled to the central computer device and configured with one or more question files containing the originating questions corresponding 1 to 1 to the derived results stored in the student record in the results file; and
a central computer device configured as a sender coupled to the storage devices, for presenting student results in a dynamic report card form across the transport medium.

9. A storage medium having stored thereon a set of instructions which, when loaded into a processor, causes the processor to perform the following functions:
receive student answers to questions;
insert the results derived from the received answers into a student record in a results file;
receive requests for a student report card from an interested party; and
present the student results and corresponding questions to an interested party in a dynamic report card unified presentation.
